(19) United States
(12) Patent Application Publication
(10) Pub. No.: US 2009/0172567 A1
(43) Pub. Date: Jul. 2, 2009

(54) DYNAMICALLY ADDED NAVIGATION WIDGET FOR LOOSE INTEGRATION OF WEB PAGES ACROSS DIFFERENT WEB APPLICATIONS

(75) Inventors: David A. Brooks, Providence, RI (US); Charles P. De Saint-Aignan, Providence, RI (US); Hiroyuki Miyamoto, Lexington, MA (US); Ethan L. Perry, Arlington, MA (US); Robert Yates, Arlington, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/967,758

(22) Filed: Dec. 31, 2007

(51) Int. Cl. G06F 3/048

(52) U.S. Cl. 715/762

(57) ABSTRACT

Embodiments of the present invention address deficiencies of the art in respect to uniform Web application navigation in a Web application environment and provide a method, system and computer program product for a dynamically added navigation widget for loosely integrating multiple Web pages. In an embodiment of the invention, a method for dynamically adding a navigation widget for loosely integrating multiple Web pages in a social network can be provided. The method can include identifying a user as either author or owner of content for Web pages loaded from different sources for viewing in a content browser, matching the user with a set of menu selections and configuring a navigation script with the set of menu selections, and returning the navigation script for embedding in each of the Web pages as a navigator.

### BACKGROUND OF THE INVENTION

1. Field of the Invention

The present invention relates to the field of Web page navigation and more particularly to a navigation widget for multiple different Web pages.

2. Description of the Related Art

The development of the World Wide Web more than a decade ago became a watershed event for the proliferation of computing from a smallish group of technologist and technology savvy individuals to the global populace. In particular, building on long standing principles of content distribution, the Web rendered computing a useful research tool accessible to even the most technologically challenged. Indeed toddlers and small children frequently access content distributed about the World Wide Web through respective Web browsers.

The utility of the World Wide Web is not limited to the global distribution of content. Rather, corporate infrastructure now relies heavily upon Web technologies to distribute content and functionality privately to members of an organization. To with, Intranet sites and internal Web applications are preferred today over traditional client server type applications because maintaining the core logic of the Web application involves only the centralized maintenance of the Web application that traditionally does not extend to the clients.

Portal environments reflect a logic progression in Web application science in that multiple different Web applications and Web content can be centrally presented in a single user interface as an aggregation. While the individual Web applications and content feeds, known as portlets, within the portal can be separately provided from separate server sources, to the end user, the aggregation of the portlets can appear as of the portal was a unified whole. In this regard, navigating from portlet to portlet in a portal environment differs little from a traditional Web page presented in a content browser.

Social networks are Web applications that combine aspects of the portal environment with the notion that people and communities of people can be interrelated in important ways despite the members in the social network often not knowing one another. In a traditional social network, the relations between users and communities of users can be inferred through common traits such as geography, role, demographics and personal and professional interests. In consequence, members of a social network can discover other relevant members in order to expand a social circle of friends and colleagues and to identify content of interest to a closely related member without having to discover the content first hand.

As part of a social network, content provided by members in blogs, bookmarks and activities can be aggregated into a single portal view. Even still, it is to be recognized that the content can be managed in separate Web applications oftentimes hosted in different servers within different domains. Thus, navigating between the Web applications can be problematic as different navigation controls necessarily must be provided for each separate Web application. Of course, uniformity in navigation can be possible if an identical navigation control is embedded at development time in each of the Web applications.

### BRIEF SUMMARY OF THE INVENTION

Embodiments of the present invention address deficiencies of the art in respect to uniform Web application navigation and provide a novel and non-obvious method, system and computer program product for a dynamically added navigation widget for loosely integrating multiple Web pages. In an embodiment of the invention, a method for dynamically adding a navigation widget for loosely integrating multiple Web pages in a social network can be provided. The method can include identifying a user as either author or owner of content for Web pages loaded from different sources for viewing in a content browser, matching the user with a set of menu selections and configuring a navigation script with the set of menu selections, and returning the navigation script for embedding in each of the Web pages as a navigator.

In one aspect of the embodiment, matching the user with a set of menu selections and configuring a navigation script with the set of menu selections can include locating an identifier for a community of users with a set of menu selections for the identifier and configuring a navigation script with the set of menu selections. In another aspect of the embodiment, matching the user with a set of menu selections and configuring a navigation script with the set of menu selections can include matching the user with a set of menu selections each corresponding to different social networking content, and configuring a navigation script with the set of menu selections. For instance, the social networking content can include a blog, a profile, a set of social bookmarks and a set of communities for the user.

In another embodiment of the invention, a Web application data processing system can be provided. The system can include a view of Web pages and a navigator including a navigation script of menu selections disposed in each of the Web pages. Finally, the system can include a framework underlying the Web pages. The framework can include program code enabled to identify a user for each of the Web pages and to embed a reference in each of the Web pages to a navigator servlet remotely disposed about a computer communications network. The servlet in turn can include program code enabled to configure the navigator as a script for execution each of the Web pages with menu selections specific to the user and to embed the script in each of the Web pages.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a dynamically addable navigation widget for loosely integrating multiple Web pages;

FIG. 2 is a schematic illustration of a Web application data processing system configured with a dynamically added navigation widget for loosely integrating multiple Web pages in the portal; and,

FIG. 3 is a flow chart illustrating a process for dynamically adding a navigation widget for loosely integrating multiple Web pages in a social network.

### DETAILED DESCRIPTION OF THE INVENTION

Embodiments of the present invention provide a method, system and computer program product for a dynamically addable navigation widget for loosely integrating multiple Web pages. In accordance with an embodiment of the present invention, a Web page can be loaded for rendering and the identity of a user or community of users defined for the Web page can be determined. The user or community of users can be compared to a remotely disposed directory to locate a set of menu selections for a navigator specified for the user or community of users. Thereafter, a navigator can be configured in script to provide the located set of menu selections and the script can be embedded in the user interface to generate the navigator. In this way, different Web pages can share a uniform navigation user interface irrespective of an underlying provider of the Web pages.

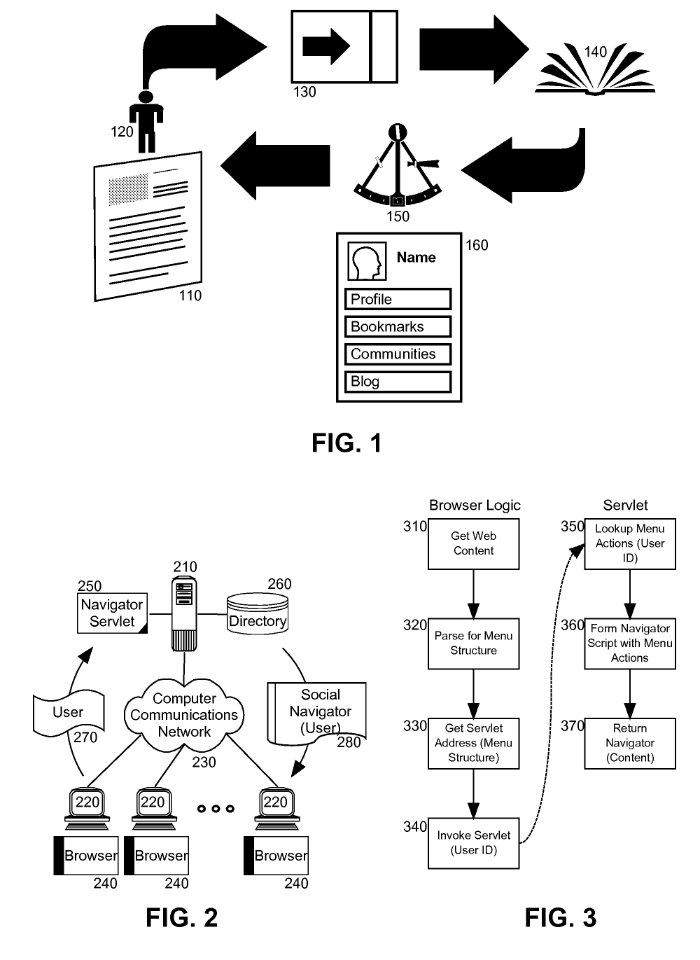

In further illustration, FIG. 1 pictorially depicts a process for embedding a dynamically addable navigation widget in a Web page in order to loosely integrate multiple Web pages with a similar navigation experience. As shown in FIG. 1, a Web page 110 can be loaded in connection with a user or community of users 120. The user or community of users 120 can be determined and compared to a directory to identify a set of menu selections 140 specific to the user or community of users 120. Thereafter, a navigator 150 can be configured with the set of menu selections 140.

In this regard, the navigator 150 can provide a navigation user interface 160 including multiple different selections, each hyperlinking to a different Web page. For example, the multiple different selections can refer individual to social networking content like a blog, profile, listing of member communities or a set of shared bookmarks for the user or community of users 120. Once the navigator 150 has been configured, the navigator 150 can be embedded in the Web page 110 so as to provide for a rendering of the navigation user interface 160.

The process shown in FIG. 1 can be provided within a Web application data processing system, for example a portal environment in which different portlet views to different Web content can be provided. In illustration, FIG. 2 schematically depicts a Web application data processing system configured with a dynamically added navigation widget for loosely integrating multiple Web pages in the portal. The system can include a host server 210 configured for communicative coupling to multiple different client platforms 220 over computer communications network 230. Content browsers 240 can be supported for operation in each corresponding one of the client platforms 220 and each of the content browsers 240 can be configured to render Web pages and to execute embedded scripts.

Importantly, a navigator servlet 250 can be coupled to the host server 250. The navigator servlet 250 can include program code enabled to receive a request for a navigator script along with a user identifier 270 for a user or community of users defined for a Web page rendered within the requesting one of the content browsers 240. The program code further can be enabled to match the user identifier 270 with an entry or entries in a directory 260 to locate a set of menu selections. Finally, the program code can be enabled to configure a social navigator script 280 with the located set of menu selections and to return the social navigator script to the Web page in the requesting one of the content browsers 240 for rendering within the Web page.

In yet further illustration, FIG. 3 is a flow chart illustrating a process for dynamically adding a navigation widget for loosely integrating multiple Web pages in a social network. The process can begin in block 310 with the loading of Web page in a Web browser. The Web page can be built on a framework configured to parse the document object model (DOM) tree in block 320 for the Web page seeking an identifier for a user or community of users. Upon locating the identifier, a source tag for a navigator servlet and the identifier can be injected into the DOM tree in block 330 and in block 340 the servlet can be invoked.

In block 350, upon receiving the request from the Web browser, the servlet can lookup a set of menu selections corresponding to the identifier in the request, each of the menu selections including both a uniform resource locator (URL) for Web content and a title or description for the Web content. In block 360 a navigator script can be parameterized with the set of menu selections such that upon execution in a Web browser, a navigator user interface can be rendered with the set of menu selections, each activated to hyperlink to respectively specified Web content like a blog, profile, set of shared bookmarks or listing of communities for a user or community of users associated with the identifier in the servlet request. Finally, in block 370, the navigator script can be returned to the Web content for rendering.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for dynamically adding a navigation widget for loosely integrating multiple Web pages in a social network, the method comprising:
identifying a user as either author or owner of content for each of a plurality of Web pages loaded from different sources of Web pages for viewing in a content browser;
matching the user with a set of menu selections and configuring a navigation script with the set of menu selections; and,
returning the navigation script for embedding in each of the Web pages as a navigator.

2. The method of claim 1, wherein matching the user with a set of menu selections and configuring a navigation script with the set of menu selections, comprises locating an identifier for a community for the user with a set of menu selections for the identifier and configuring a navigation script with the set of menu selections.

3. The method of claim 1, wherein matching the user with a set of menu selections and configuring a navigation script with the set of menu selections, comprises matching the user with a set of menu selections each corresponding to different social networking content, and configuring a navigation script with the set of menu selections.

4. The method of claim 1, wherein matching the user with a set of menu selections and configuring a navigation script with the set of menu selections, comprises matching the user with a set of menu selections each menu selection corresponding to a blog, a profile, a set of social bookmarks and a set of communities for the user, and configuring a navigation script with the set of menu selections.

5. A Web application data processing system comprising:
a view of a plurality of Web pages;
a navigator comprising a navigation script of menu selections disposed in each of the Web pages and,
a framework underlying the Web pages comprising program code enabled to identify a user for each of the Web pages and to embed a reference in each of the Web pages to a navigator servlet remotely disposed about a computer communications network, the servlet comprising program code enabled to configure the navigator as a script for execution each of the Web pages with menu selections specific to the user and to embed the script in each of the Web pages.

6. The system of claim 5, wherein the menu selections comprises links to social networking content.

7. The system of claim 6, wherein the social networking content is a blog for the user.

8. The system of claim 6, wherein the social networking content is a profile for the user.

9. The system of claim 6, wherein the social networking content is a set of shared bookmarks for the user.

10. The system of claim 6, wherein the social networking content is a listing of communities for the user.

11. A computer program product comprising a computer usable medium embodying computer usable program code for dynamically adding a navigation widget for loosely integrating multiple Web pages in a social network, the computer program product comprising:
computer usable program code for identifying a user as either author or owner of content for each of a plurality of Web pages loaded from different sources of Web pages for viewing in a content browser;
computer usable program code for matching the user with a set of menu selections and configuring a navigation script with the set of menu selections; and,
computer usable program code for returning the navigation script for embedding in each of the Web pages as a navigator.

12. The computer program product of claim 11, wherein the computer usable program code for matching the user with a set of menu selections and configuring a navigation script with the set of menu selections, comprises computer usable program code for locating an identifier for a community for the user with a set of menu selections for the identifier and configuring a navigation script with the set of menu selections.

13. The computer program product of claim 11, wherein the computer usable program code for matching the user with a set of menu selections and configuring a navigation script with the set of menu selections, comprises computer usable program code for matching the user with a set of menu selections each corresponding to different social networking content, and configuring a navigation script with the set of menu selections.

14. The computer program product of claim 11, wherein the computer usable program code for matching the user with a set of menu selections and configuring a navigation script with the set of menu selections, comprises computer usable program code for matching the user with a set of menu selections each menu selection corresponding to a blog, a profile, a set of social bookmarks and a set of communities for the user, and configuring a navigation script with the set of menu selections.
